(19) United States
(12) Patent Application Publication
(10) Pub. No.: US 2022/0114660 A1
(43) Pub. Date: Apr. 14, 2022

(54) METHODS AND SYSTEMS FOR RENDERING A LINE OF CREDIT MICRO LOAN

(71) Applicant: Huntington Bancshares Incorporated, Columbus, OH (US)

(72) Inventors: Bryan James Carson, New Albany, OH (US); Mark Richard Rhoades, Columbus, OH (US)

(21) Appl. No.: 17/140,830

(22) Filed: Jan. 4, 2021

Related U.S. Application Data
(60) Provisional application No. 63/089,380, filed on Oct. 8, 2020.

(51) Int. Cl. G06Q 40/02; G06Q 20/40; G06Q 20/24; G06Q 20/26

(52) U.S. Cl. CPC G06Q 40/025; G06Q 20/26; G06Q 20/24; G06Q 20/405

(57) ABSTRACT

Methods and systems for rendering a line of credit micro loan have been disclosed. The method may be carried out by a server's processor executing code stored in a non-transitory computer-readable medium to carry out steps including: evaluating borrower's eligibility for approval of a micro loan, which an amount of the micro loan may be determined based on borrower's account relationship with a financial institution. The method may advance funds up to the approved amount into the borrower's at least one opened deposit account. The micro loan may be repaid through automatic debiting from one of borrower's at least one opened deposit account over a repayment period.

### CROSS-REFERENCE

The present application claims the benefit of priority under 35 U.S.C. § 119 from U.S. Provisional Patent Application Ser. No. 63/089,380 entitled “METHODS AND SYSTEMS FOR RENDERING A LINE OF CREDIT MICRO LOAN,” filed on Oct. 8, 2020, the disclosure of which is hereby incorporated by reference in its entirety for all purposes.

### TECHNICAL FIELD

The present disclosure generally relates to financial management systems and loan products and services, and more specifically relates to methods and systems for rendering a line of credit in the form of a small dollar line of credit (aka micro loan).

### BACKGROUND

Customers who may face financial hardship and devastation often need temporary financial relief and help from, for example, their financial institutions. Such relief is difficult to qualify for and usually comes at a high cost that further reduces a net amount of relief that they may receive.

The description provided in the background section should not be assumed to be prior art merely because it is mentioned in or associated with the background section. The background section may include information that describes one or more aspects of the subject technology.

### BRIEF DESCRIPTION OF DRAWINGS

The disclosure is better understood with reference to the following drawings and description. The elements in the figures are not necessarily to scale, emphasis are instead being placed upon illustrating the principles of the disclosure. Moreover, in the figures, like-referenced numerals may designate to corresponding parts throughout the different views.

FIG. 1 illustrates an example of a computer implemented method of rendering a micro loan to a borrower.

FIG. 2 illustrates an example of a server that renders a micro loan to a mobile terminal of a borrower in a communication system.

FIGS. 3A-3C illustrate examples of screenshots of a mobile application which renders a digital micro loan to an eligible borrower and an ineligible borrower.

FIG. 4 illustrates an example of the digital micro loan product features offered by a financial institution.

FIGS. 5A-5D illustrate exemplary screenshots of online enrollment of a micro loan offered by a financial institution.

FIGS. 6A-6C illustrate exemplary mobile banking screenshots to transfer funds into a borrower's deposit account.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### SUMMARY

Throughout the disclosure, the term “micro loan” and “line of credit” may be used interchangeably. In an example, the disclosure describes a computer implemented method of rendering a micro loan to a borrower that is carried out by a server having at least a processor executing at least one code stored in a non-transitory computer-readable medium which causes the server to perform steps. The method includes a step of evaluating a borrower's eligibility in a database by evaluating the borrower's account relationship with a financial institution against defined decisioning criteria for approving a micro loan as a small dollar amount line of credit, where the borrower has at least one opened (e.g., checking, savings, money-moving or others) deposit account with recurring deposits made at the financial institution. The method includes a step of determining an approved amount of the micro loan for the borrower based on the borrower's account relationship with the financial institution. The method includes a step of, through a mobile account or on-line account, advance funds up to the approved amount of the micro loan, by on-line transferring into one of the at least one opened deposit account of the borrower, which may or may not be the same account used to determine the approved amount, wherein the advanced funds are to be fully repaid (by at least equal installments or alternately paid in full) over a defined repayment time period, with or without a service charge and with or without interests charged by the financial institution. The borrower may repay the funds using one or more of accounts owned by the borrower, such as from checking, savings, money-moving or other deposit account, which may or may not be from the same account used to determine the approved amount or from the same account that the advanced funds were deposited into. The method includes a step of, automatically in each repayment period, debiting from one of the at least one opened deposit account (e.g., one or more of: checking, savings, money-moving or other deposit account at the financial institution) of the borrower, a repayment amount of no less than an equal installment which is calculated by amortizing the advanced funds over the defined repayment time period in equal installments, wherein additional fund advances are permissible during the defined repayment time period. As mentioned, it is possible that this micro loan could charge a nominal interest rate or service charge fee and in this event, the repayment amount would account for this rate or fee. If the borrower is enrolled in automatic repayment plan, the service charge or interest may be waived.

In another example, the disclosure describes a non-transitory computer-readable medium which stores at least one code, when executed by at least a processor in a computer, causes the computer to render a micro loan to a borrower by performing steps in a method. The method includes evaluating a borrower's eligibility in a database by evaluating a borrower's account relationship with a financial institution against defined decisioning criteria for approving a micro loan, where the borrower has at least one opened deposit account with recurring deposits made at the financial institution. The eligibility determination may also include determining an approved amount of the micro loan for the borrower based on the borrower's deposit account relationship, for example a checking account. The method includes, through mobile banking or on-line banking, advancing funds up to the approved amount for the micro loan, by on-line transferring into one of the at least one opened deposit account of the borrower, wherein the advanced funds are to be fully repaid over a defined repayment time period with or without a service charge and with or without interests charged by the financial institution. The method includes, directly for each repayment period, debiting from one of the at least one opened deposit account (moving money from one or more of: checking, savings, money-moving, or other deposit account) of the borrower at the financial institution, a repayment amount according to a repayment plan or repayment structure. In one embodiment, this repayment amount may be no less than an equal installment which is calculated by amortizing the advanced funds over the defined repayment time period in equal installments. Alternately the borrower may make multiple repayments or even prepay the entire balance without penalty. During the repayment period, additional fund advances may be permissible during the defined repayment time period, as long as a loan utilization rate is not exceeded.

### DETAILED DESCRIPTION

In the following, only certain examples are briefly described. As those in the art would realize, the described examples may be modified in various different ways, all without departing from the spirit or scope of the present disclosure. Throughout the disclosure, the term “customer” may be interchanged with the term “borrower” to mean that the customer may also be the borrower.

An income and savings survey found that about 83% of customers of financial institutions may benefit from a micro loan of a small dollar lines of credit (aka digital micro loans) in a form of a financial product that may temporarily relieve financial hardship and meet a long felt need of customers of financial institutions. Digital micro loans (DML) may be based solely on an account relationship that offers a free line of credit (for example, interest or fees waived after enrollment into automatic repayment plan) or low cost line of credit (for example, if not enrolled into automatic repayment plan) with an approved amount based on a decisioning criteria of a customer's checking relationship, and not based on their credit score from a credit bureau. For example, the line of credit may be opened by a customer through mobile or online account. The line of credit may report to all 3 credit bureaus, so proper usage and on-time payment can help improve credit scores of the customer. Funds may be immediately transferrable into an eligible borrower's at least one opened deposit account, such as, but not limited to, a checking account, a savings account, a money-moving account, or other deposit account, through mobile or online account. Eligibility and credit line are determined by the borrower's checking account and relationship activity with the financial institution which will be transparent to the borrower in the product disclosures so that the moment a borrower is no longer eligible, the product may disappear (e.g., no longer be presented) or be disabled from online and mobile accounts.

In an embodiment, the financial institution may proactively offer a small dollar amount line of credit in the form of a micro loan that features zero percent (0%) Advance Fee and 0% APR interest to its customers who have at least one open checking account with recurring deposits. Although the line of credit is based on a decisioning criteria primarily of a customer's checking relationship, and not their credit score from a credit bureau, borrower's usage and on time repayments may help to build customer's credit score. The micro loan may allow immediate (with no waiting grace period) access to funds in just a few clicks on a mobile application or online banking website, and repayment may be based on a schedule (such as equal monthly installments) with no pre-payment penalty. In addition, the line of credit may function as an overdraft protection with no or low service charge to both save on overdraft fees and more expensive short-term credit options like payday lending, for example. A vast majority (90%+) of primary checking customers may qualify to be able to use this line of credit product as a temporary relief during hardship. In certain aspects, each fund advance may cause the monthly payments to be recalculated to bring a balance down to $0 over a repayment period, in an example, such repayment period may be 90 days.

To discourage debt accumulation and delinquency, the program that renders the micro loan may have a built-in cool-off logic to prevent an additional advance if/when a balance reaches a utilization of X % of the credit line or when a utilization rate reaches a threshold number of times of cash advance within a defined time period (e.g., >Y numbers advances per month). In certain aspects, the cool-off logic may require the customer to pay the line of credit balance to $0 before the borrower may resume taking an additional advance. There are various approaches for determining an approved loan amount. These approaches may include considering the account opening date, account balances, monthly deposit dollar amounts, account activity, and number of overdraft occurrences over a course of time. The approach may involve using some type of scoring system to determine an approved amount, including where the amount is zero and effectively the borrower does not qualify.

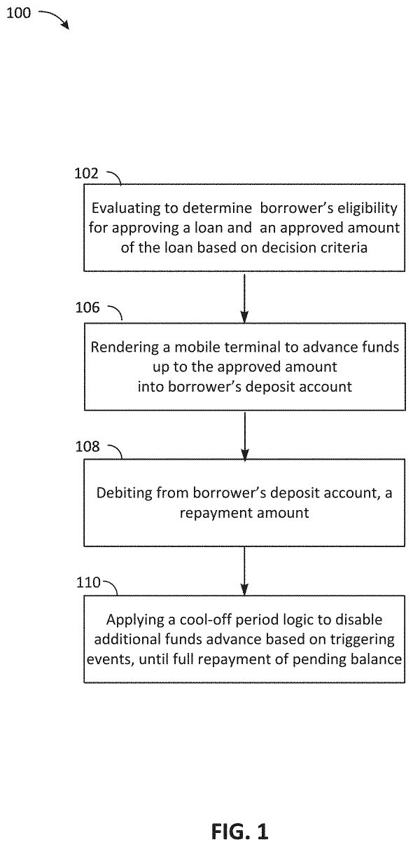

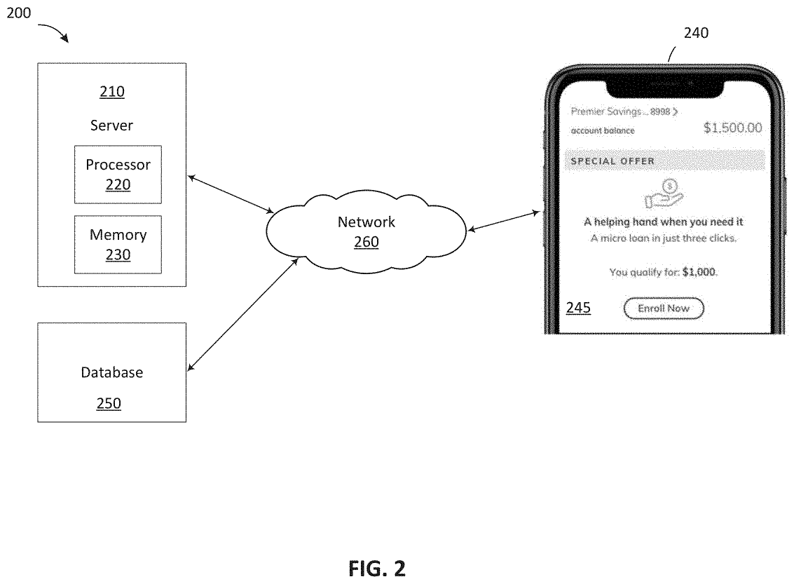

A computer implemented method of rendering a micro loan to a borrower and a non-transitory computer-readable medium which stores executable program code, when executed by at least a processor in a computer, causes the computer to render a micro loan to a borrower is exemplarily illustrated by FIGS. 1-2. More specifically, FIG. 1 illustrates an example of a computer implemented method 100 of rendering a micro loan to a borrower, and FIG. 2 illustrates an example of a server 210 that renders a micro loan to a mobile terminal 240 of a borrower in a communication system 200.

The computer may be a server 210 having at least a processor 220 executing program code stored in a non-transitory computer-readable medium or a memory 230 to cause the server 210 to perform a method such as those in the following steps. In step 102, the server 210, executing at least one code, may perform determining an approved amount of the micro loan (if any). In practice, the server 210 may query a database 250 to evaluate the borrower's account relationship with a financial institution as a part of decisioning criteria for approving the micro loan. For example, the borrower may have at least one opened checking (and/or savings, or other money-moving account) deposit account with recurring deposits made at the financial institution. The eligibility of the borrower depends primarily on the borrower's checking account relationship, and not their credit score from a credit bureau. For example, the server may evaluate, as a primary consideration, how long the borrower's at least one checking account(s) with recurring deposits has been opened with the financial institution. Other primary considerations may include a recurring deposit amount, an average total balance of all of the borrower's checking account(s) over a period, such as, but not limited to, a most recent period of two to three statement periods. In certain aspects, determining the approved amount of the micro loan may include evaluating periodically, borrower's average monthly recurring deposits, number of overdraft occurrences, and an average daily balance of the at least one opened deposit account. Furthermore, borrower's subsequent limit of approved amount of the micro loan may be adjusted based on a periodic review of borrower's repayment history and banking relationship.

In step 106, the server 210, executing at least one code, may perform through a communication network 260, rendering a mobile terminal 240 of the borrower through a mobile application program interface (API) 245, to perform electronic fund advance up to the approved amount into borrower's one of at least one opened checking, savings, money-moving, or other deposit account. The advanced funds are to be fully repaid over a defined repayment time period with or without a service charge and with or without interests charged by the financial institution. As mentioned, this repayment may be made through various types of fund transfers, including moving money from one or more of: checking, savings, money-moving, or other deposit account of the borrower. While the micro loan may initially be structured to have no service charges and no interest (including when enrolled in automatic repayment plan), it may be possible to subsequently alter this and later charge a fee or interest with proper customer notification. It may also be possible to waive charges and fees if the borrower is enrolled into an automatic repayment program. For example, FIG. 2 illustrates that the borrower has been approved with a micro loan of $1,000. Funds may be transferred from the line of credit account into the borrower's at least one opened deposit account through a graphical user interface (GUI) in the mobile application (API 245).

In step 108, the server 210, executing at least one code, may perform directly and automatically in each repayment period, debiting, from one of the at least one opened deposit account of the borrower, a repayment amount will be calculated for all advance(s) taken during a statement cycle amortizing a total balance of the advanced funds into three equal payments over a defined repayment period (e.g., 90 days or three months). In an example, if the repayment period is three (3) months, there may be three equal payment installments. Alternately, six (6) bi-monthly payment installments may be amortized to be debited from each recurring deposit. Each subsequent fund advance made after the statement cycle may be added to the total balance for calculation of a subsequent equal payments amortized over a subsequent defined repayment time period amount for a next statement cycle. Additional fund advances are permissible during the defined repayment time period. Other repayment calculations could include amortizing the full repayment amount (existing balance plus new advances) over equal installments for a repayment period of 3-6 months. Other repayment structures exist and could be utilized over the repayment period, including custom repayment, one-time repayment, and scheduled or unscheduled repayments.

In step 110, the server 210, executing at least one code, may apply a cool-off period logic function when encountering triggering events to disable funds advance function until full repayment of a pending balance. For example, the triggering events may include when a micro loan balance reaches a threshold percentage of the approved amount over a set period of time or when funds advance frequency exceeds a threshold number within a month. Other events that may also trigger a cool-off period may include unsuccessful attempts to debit a repayment installment from one of the at least one opened deposit account or lapsing of recurring deposits. In another example, the customer may transfer money from other accounts, such as from other checking or savings account within the financial institution, into one of the at least one deposit account, or directly to the financial institution, to make the repayment or automatic debits.

The server 210, executing at least one code, may perform recalculating a minimum monthly repayment installment amount to facilitate full repayment of a pending balance within the defined repayment time period. To enforce good behavior in repayment, a successful debiting of the minimum monthly repayment installment from one of the at least one opened or other deposit account by a due date may be reported to a credit bureau as a positive credit rating of the borrower, wherein if the minimum monthly repayment installment from one of the at least one opened deposit account on the due date is not received, subsequent deposits to one of the at least one opened deposit account may be prioritized to be first debited to meet the minimum monthly repayment installment obligation, wherein a negative credit rating may be reported to the credit bureau.

A pending balance of the line of credit micro-loan may be repaid at any time after borrowing without a pre-payment penalty. The repayment period is usually short term, which may be set to no more than ninety days or other shorter or longer time period. In another embodiment, the borrower may have the ability to customize a repayment plan. The funds advance from the micro loan may be used as an overdraft protection feature with no overdraft service charge to one of the at least one opened deposit account of the borrower. In an exemplary case, if a pending balance of the micro loan is less than a threshold amount (for example, under $35), the server 210, executing the at least one code, may program an entire pending balance (in this example, $35) of the micro loan to be automatically debited from one of the at least one opened deposit account on the due date.

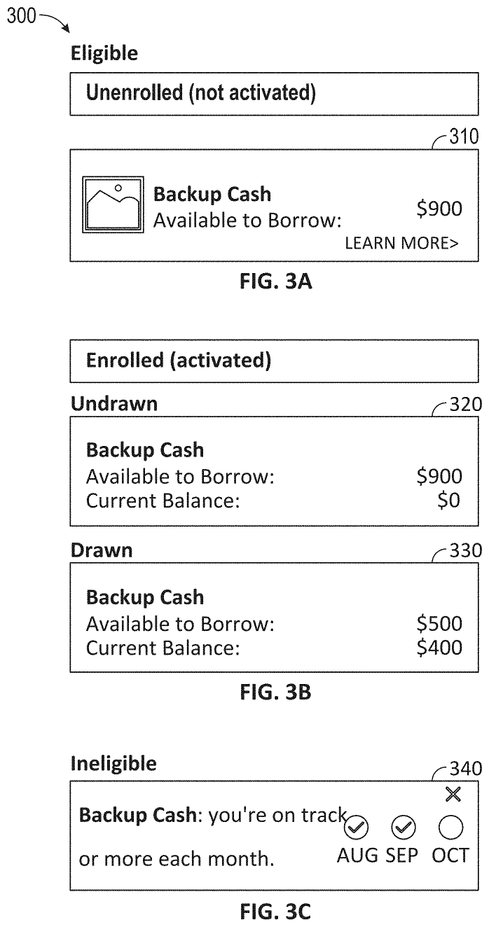

FIGS. 3A to 3B illustrate an example of a screenshot of a mobile application which renders a digital micro loan to an eligible borrower and FIG. 3C illustrates a screenshot of a message to an ineligible borrower. FIG. 3A illustrates that a line of credit of $900 may be available to an eligible borrower. The borrower may transfer $500 cash into the checking account, leaving a remaining line of credit of $400 still available for future transfer, as shown in FIG. 3B. FIG. 3C illustrates a scenario of an ineligible borrower who may not be approved for a loan due to a low balance in the checking account, but if the balance reaches $750, the borrower may be eligible for a micro loan with a limit set at $900.

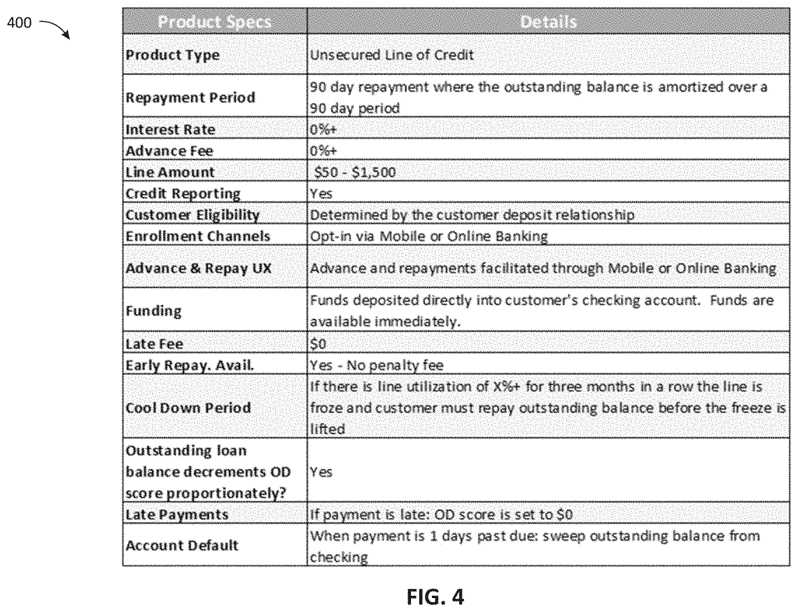

FIG. 4 illustrates an example of the digital micro loan product features 400, where a line of credit micro loan up to $1,500 may be available, and a funds advance amount no less than $50 may be transferred through on-line banking or mobile banking into the borrower's checking account or into another opened deposit accounts including another checking account or a savings account. No service charge, interest or late fee will be levied on this micro loan during the repayment period. It may be possible to subsequently later charge a fee or interest with proper customer notification based on re-evaluation of banking relationship.

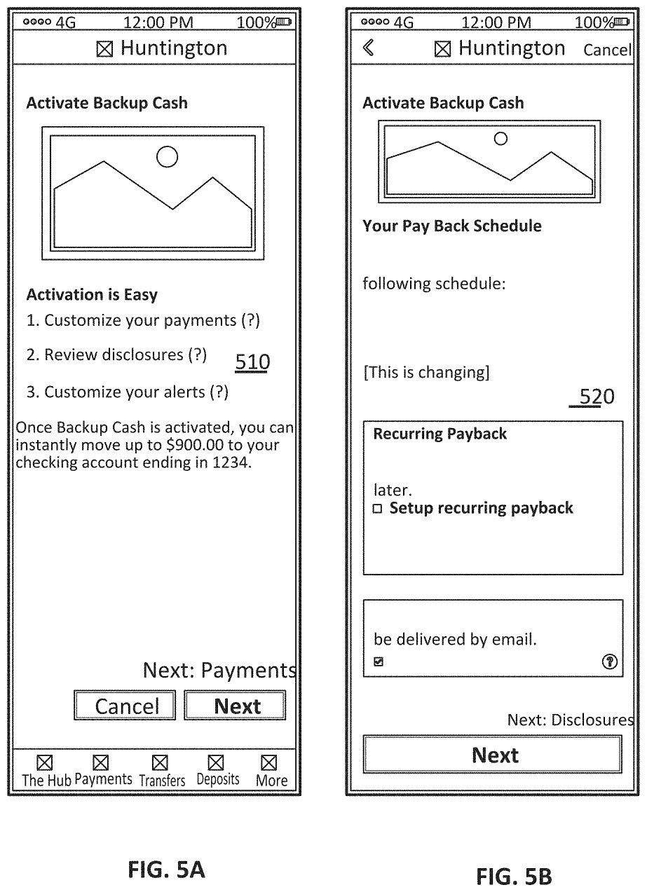

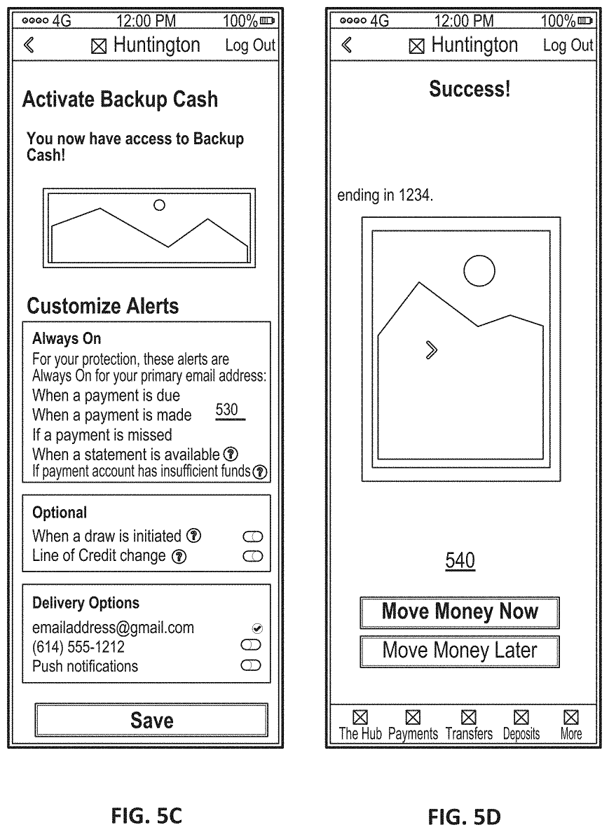

FIGS. 5A-5D illustrate exemplary screenshots of online enrollment of a micro loan offered by a financial institution. FIG. 5A displays a screenshot 520 which lists out funds advancement enrollment steps 1-2-3 to be reviewed and followed by the borrower. FIG. 5B displays a screenshot 530 which discloses repayment period, in an example, the micro loan may be amortized over a repayment period of 90 days. In other words, each installment payment is ⅓ of the loan balance in each repayment period (i.e., 30 days). Screenshot 530 in FIG. 5C includes disclosure of repayment alerts. Screenshot 540 in FIG. 5D discloses completion of enrollment which a borrower may start to advance funds from an approved micro loan.

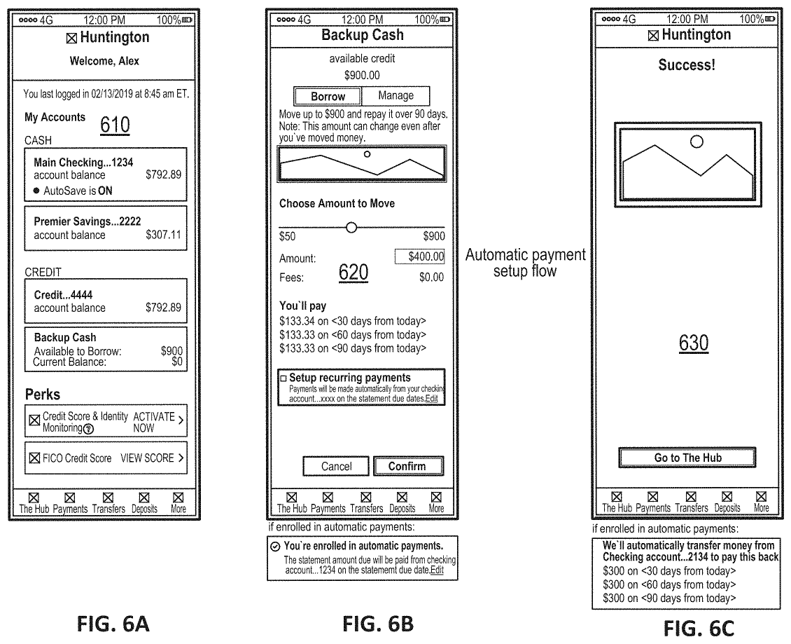

FIGS. 6A-6C illustrate exemplary mobile banking screenshots to transfer fund into a borrower's checking account. FIG. 6A displays a screenshot which an approved amount of $900.00 as back up cash may be advanced and borrowed borrower's checking account. FIG. 6B displays a screenshot of an example which an amount of $400.00 is advanced without interests. A repayment amount of $133.33 is calculated by amortizing $400.00 in three installments over a three-month repayment period. FIG. 6C displays a screenshot of another example which a full amount of $900 is advanced without interests. A repayment amount of $300.00 is calculated by amortizing $900.00 in three installments over a three-month repayment period.

Various aspects of the claimed subject matter above have been described herein and by the appended claims without limiting within the scope of the claimed subject matter.

1. A computer implemented method of processing a loan to a borrower, comprising executing by at least a processor in a server, at least one code stored in a non-transitory computer-readable medium which causes the server to perform steps, comprising:
determining a borrower's eligibility by evaluating information about the borrower's account relationship with a financial institution against decisioning criteria for approving a loan offer, where the borrower has at least one opened deposit account with recurring deposits made at the financial institution;
through a communication network, proactively communicating the loan offer to a mobile terminal of the borrower for immediate acceptance by the borrower, by causing a graphical user interface on the mobile terminal, through a mobile account or on-line account of the borrower, to display information of the loan offer, wherein the graphical user interface is configured to allow immediate acceptance of the loan offer;
responsive to receiving the acceptance of the loan offer from the mobile terminal, via the graphical user interface, processing a funds advance up to the approved amount of the loan, by on-line transferring, into one of the at least one opened deposit account of the borrower at the financial institution, wherein the advanced funds are to be fully repaid within a defined repayment time period according to a repayment structure;
responsive to receiving the acceptance of the loan offer from the mobile terminal, via the graphical user interface, enabling a cool-off logic to monitor triggering events for allowing and disallowing additional funds transfer to the mobile account or on-line account of the borrower to prevent debt accumulation and loan delinquency of the borrower, wherein the graphical user interface is configured to, based on the cool-off logic monitoring the triggering events, display additional funds transfer availability and disable additional funds transfer when one of the triggering events is encountered; and
within the defined repayment period according to the repayment structure, processing the debiting of at least a repayment from one of the at least one opened deposit account of the borrower at the financial institution.

2. The computer implemented method of claim 1, wherein the cool-off logic, via the graphical user interface, disallows additional funds transfer based on encountering one of the trigger events, wherein one of the trigger events is one of when a balance of the loan reaches a threshold percentage of the approved amount and when a utilization rate reaches a threshold number of times with a defined time period until after full repayment of a pending balance.

3. The computer implemented method of claim 1, wherein the debiting of at least the repayment from one of the at least one opened deposit account further comprising moving money via the graphical user interface, from anyone of: checking, savings or other deposit account of the borrower at the financial institution, wherein the repayment according to the repayment structure is calculated from all advance(s) taken during a statement cycle by amortizing a total balance of the advanced funds into equal payments over the defined repayment time period, wherein each subsequent fund advance made after the statement cycle is added to the total balance for calculation of a subsequent equal payments over a subsequent defined repayment time period amount for a next statement cycle.

4. The computer implemented method of claim 3, wherein a successful debiting of the repayment payment from one of the at least one opened deposit account by due date is reported to a credit bureau as a positive credit rating of the borrower.

5. The computer implemented method of claim 4, wherein if the repayment amount is not received according to the repayment structure, subsequent depo sits to one of the at least one opened deposit account are automatically debited until the minimum monthly repayment installment is met, wherein a negative credit rating is reported to the credit bureau.

6. The computer implemented method of claim 1, wherein the determining of the approved amount of the loan comprising evaluating borrower's average monthly recurring deposits and an average daily balance of the at least one opened deposit account.

7. The computer implemented method of claim 6, comprising adjusting borrower's subsequent limit of approved amount of the loan based on a periodic review of borrower's repayment history and credit score.

8. The computer implemented method of claim 1, wherein there is no pre-payment penalty to pay off a pending balance of the loan, and the repayment period is set to no more than ninety days.

9. The computer implemented method of claim 1, wherein the funds advance from the loan is an overdraft protection feature with no overdraft service charge to the at least one opened deposit account of the borrower.

10. The computer implemented method of claim 1, wherein if a pending balance is less than a threshold amount, an entire pending balance of the loan will automatically be debited from one of the at least one opened deposit account as part of a repayment under the repayment structure.

11. A non-transitory computer-readable medium which stores at least one code, when executed by at least a processor in a computer, causes the computer to render a loan to a borrower by performing steps in a method, comprising:
determining a borrower's eligibility by evaluating information about the borrower's account relationship with a financial institution against decisioning criteria for approving a loan offer, where the borrower has at least one opened deposit account with recurring deposits made at the financial institution;
through a communication network, proactively communicating the loan offer to a mobile terminal of the borrower for immediate acceptance by the borrower, by causing a graphical user interface on the mobile terminal, through a mobile account or on-line account of the borrower, to display information of the loan offer, wherein the graphical user interface is configured to allow immediate acceptance of the loan offer;
responsive to receiving the acceptance of the loan offer from the mobile terminal, via the graphical user interface, processing a funds advance up to the approved amount of the loan, by on-line transferring, into one of the at least one opened deposit account of the borrower at the financial institution, wherein the advanced funds are to be fully repaid within a defined repayment time period according to a repayment structure;
responsive to receiving the acceptance of the loan offer from the mobile terminal, via the graphical user interface, enabling a cool-off logic to monitor triggering events for allowing and disallowing additional funds transfer to the mobile account or on-line account of the borrower to prevent debt accumulation and loan delinquency of the borrower, wherein the graphical user interface is configured to, based on the cool-off logic monitoring the triggering events, display additional funds transfer availability and disable additional funds transfer when one of the triggering events is encountered; and
within the defined repayment period according to the repayment structure, processing the debiting of at least a repayment from one of the at least one opened deposit account of the borrower at the financial institution.

12. (canceled)

13. The non-transitory computer-readable medium of claim 11, wherein the debiting of at least the repayment from one of the at least one opened deposit account further comprising moving money from anyone of: checking, savings or other deposit account of the borrower at the financial institution, wherein the repayment according to the repayment structure is calculated from all advance(s) taken during a statement cycle by amortizing a total balance of the advanced funds into equal payments over the defined repayment time period, wherein each subsequent fund advance made after the statement cycle is added to the total balance for calculation of a subsequent equal payments over a subsequent defined repayment time period amount for a next statement cycle.

14. The non-transitory computer-readable medium of claim 13, wherein a successful debiting of the repayment payment from one of the at least one opened deposit account by due date is reported to a credit bureau as a positive credit rating of the borrower.

15. The non-transitory computer-readable medium of claim 14, wherein if the repayment amount is not received according to the repayment structure, subsequent deposits to one of the at least one opened deposit account are automatically debited until the minimum monthly repayment installment is met, wherein a negative credit rating is reported to the credit bureau.

16. The non-transitory computer-readable medium of claim 11, wherein the determining of the approved amount of the loan comprising evaluating borrower's average monthly recurring deposits and an average daily balance of the at least one opened deposit account.

17. The non-transitory computer-readable medium of claim 16, wherein the executed at least one code comprising adjusting borrower's subsequent limit of approved amount of the loan based on a periodic review of borrower's repayment history and credit score.

18. The non-transitory computer-readable medium of claim 11, wherein there is no pre-payment penalty to pay off a pending balance of the loan, and the repayment period is set to no more than ninety days, if a pending balance is less than a threshold amount, the executed at least one code renders an entire pending balance of the loan to automatically be debited from one of the at least one opened deposit account.

19. The non-transitory computer-readable medium of claim 11, wherein the funds advance from the loan is an overdraft protection feature with no overdraft service charge to the at least one opened deposit account of the borrower.

20. A server configured to process a loan to a borrower, the server comprising at least a processor that executes at least one code stored in a non-transitory computer-readable medium, wherein the executed at least one code configures the server to:
determine a borrower's eligibility by evaluating information about the borrower's account relationship with a financial institution against decisioning criteria for approving a loan offer, where the borrower has at least one opened checking, savings, money-moving or other deposit account with recurring deposits made at the financial institution;
through a communication network, proactively communicate the loan offer to a mobile terminal of the borrower for immediate acceptance by the borrower, by causing a graphical user interface on the mobile terminal, through a mobile account or on-line account of the borrower, to display information of the loan offer, wherein the graphical user interface is configured to allow immediate acceptance of the loan offer;
process, responsive to receiving the acceptance of the loan offer from the mobile terminal, via the graphical user interface, a funds advance up to the approved amount of the loan, by on-line transferring, into one of the at least one opened deposit account of the borrower at the financial institution, wherein the advanced funds are to be fully repaid within a defined repayment time period according to a repayment structure;
enable, responsive to receiving the acceptance of the loan offer from the mobile terminal, via the graphical user interface, a cool-off logic to monitor triggering events for allowing and disallowing additional funds transfer to the mobile account or on-line account of the borrower to prevent debt accumulation and loan delinquency of the borrower, wherein the graphical user interface is configured to, based on the cool-off logic monitoring the triggering events, display additional funds transfer availability and disable additional funds transfer when one of the triggering events is encountered; and
within the defined repayment period according to the repayment structure, process the debiting of at least a repayment from one of the at least one opened deposit account of the borrower at the financial institution.
